(19) United States
(12) Patent Application Publication
(10) Pub. No.: US 2008/0034428 A1
(43) Pub. Date: Feb. 7, 2008

(54) ANTI-PHISHING FOR CLIENT DEVICES

(75) Inventors: Arturo Bejar, Saratoga, CA (US); Naveen Agarwal, Fremont, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/458,048

(22) Filed: Jul. 17, 2006

(51) Int. Cl. G06F 12/14

(52) U.S. Cl. 726/23

(57) ABSTRACT

A network device and method are directed towards providing a client side identification mechanism for use detecting phishing attempts. In one embodiment, a user of a client device may provide anti-phishing data through an anti-phish setup interface for a website, application, or the like. In one embodiment, the anti-phishing data is an image. The client device then receives client device data indicating the website, application, or the like, for which the anti-phishing data is associated and where the anti-phishing data is located. In one embodiment, the client device data is received in the form of a cookie. When the user of the client device accesses the website, application, or the like, the client device may provide the client device data which is then used to locate and display the anti-phishing data. If the user is being phished, the anti-phishing data may not be displayed or otherwise played.

### BACKGROUND OF THE INVENTION

The present invention relates generally to computing security, and more particularly but not exclusively to providing a client device based phishing detection mechanism.

A major type of internet fraud, today, is known as phishing. Phishing typically involves the practice of obtaining confidential information through the manipulation of legitimate users. Typically, the confidential information is a user's password, credit card details, social security number, or other sensitive user information. Phishing may be carried out by masquerading as a trustworthy person, website, or business. In one approach, a message may be sent to an unsuspecting user. The message may include a link or other mechanism that links to an illegitimate source. In another approach, a webpage that may appear to be legitimate is provided to the user. However, the webpage (or message) is designed to trick the user into providing their confidential information. Such webpages (or messages) may relate to account log-in sites, credit card entry sites, or the like. Once the unsuspecting user enters their information, the phisher may be able to obtain the sensitive information and use it to create fake accounts in a victim's name, ruin the victim's credit, make purchases under the victim's name, sell the information to others, perform acts under the victim's identity, or even prevent the victim from accessing their own money and/or accounts.

Unfortunately, this type of fraudulent activity is becoming more popular, primarily because of how easy it is to convince people to divulge their sensitive information over the internet. It has been estimated that between May 2004 to May 2005, for example, over one million computer users in the United States suffered over $900 million in losses due to such fraudulent phishing schemes. Because victims to these attack may reduce their activities over the internet with websites that have been phished, many legitimate businesses may also suffer both financially, and in their reputation.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Descriptions, which is to be read in association with the accompanying drawings, wherein:

FIG. 1 shows a functional block diagram illustrating an environment for practicing the invention;

FIG. 2 shows one embodiment of a client device that may be employed;

FIG. 3 shows one embodiment of a network device that may be employed to provide an anti-phishing service;

FIG. 4 illustrates a flow diagram generally showing one embodiment for a client process of managing a client side authenticating a communication over a network; and

FIG. 5 illustrates a flow diagram generally showing one embodiment for a server or service oriented process of managing a client side authenticating a communication over a network in accordance with the invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The terms “sensitive,” and “confidential” information refer to any information that a user would prefer not to be widely distributed. Such information may be something that the user knows, such as their social security number, a password, encryption key number, credit card number, financial information, driver's license number, insurance number, mother's maiden name, or the like. The information may also represent data about the user, including, for example, their age, birth date, medical information, or the like.

HTTP cookies are described in RFC 2109, available through the IETF. A slightly different description is provided through Netscape's Support Documentation, entitled “Persistent Client State HTTP Cookies.” As used herein, the term “cookie” refers to information that gets passed from a server to a client, and passed back by the client and substantially conforms to the descriptions of cookies in the above documents. Such information may be passed in both directions in an HTTP header. A cookie generally includes a name-value pair, and the term cookie may refer to the value, the name, or the combination of both, or a part of the combination. As used herein, a server may send the client a cookie, and the client may return the cookie it received, and both the sent and returned information is considered to be the same cookie.

Briefly, the present invention is directed towards a method, apparatus, and system for providing client side identification for use in detecting phishing attempts. A user of a client device may select a website, application, or the like, for which to associate a client side identification mechanism. The user may provide anti-phishing data through an anti-phishing setup interface. In one embodiment, the user provides the anti-phishing data absent being requested to or otherwise providing user authentication information. Thus, in one embodiment, the anti-phishing data may be user independent. In another embodiment, the anti-phishing data is based, at least in part, on a user authentication for the client device (such as, for example, a user log-in to a client device's operating system's managed account, or the like).

The anti-phishing data may include an image, text data, audio data, characteristics about how to display the anti-phishing data, or the like. In one embodiment, the anti-phishing data may be converted to an image file. The client device may then receive encrypted client device data indicating the website, application, or the like, for which the anti-phishing data is associated. The client device data may also include information on where the anti-phishing data is located. In one embodiment, the client device data is structured to be specific to the website, application, or the like. For example, in one embodiment, the client device data is received in the form of a cookie. When the user of the client device accesses the website, application, or the like, the client device may provide the client device data. In one embodiment, the client device data may only be decrypted by an authentic website. The client device data may then be used to locate and display and/or play the anti-phishing data. In one embodiment, the anti-phishing data is provided in a transient form, such as a URL, or the like, that may change or otherwise be non-permanent. If the user is being phished, the anti-phishing data may not be displayed (or played). When the anti-phish is not displayed (or played), the user may conclude that the website, application, or the like, is not authentic, or that the user is being phished, or the like, and may then take an appropriate response.

Although the above embodiments are described in terms of a client-server architecture, the invention is not so limited. For example, various embodiments may also employ a server to server, or even a peer to peer architecture, without departing from the scope of the invention.

### Illustrative Environment

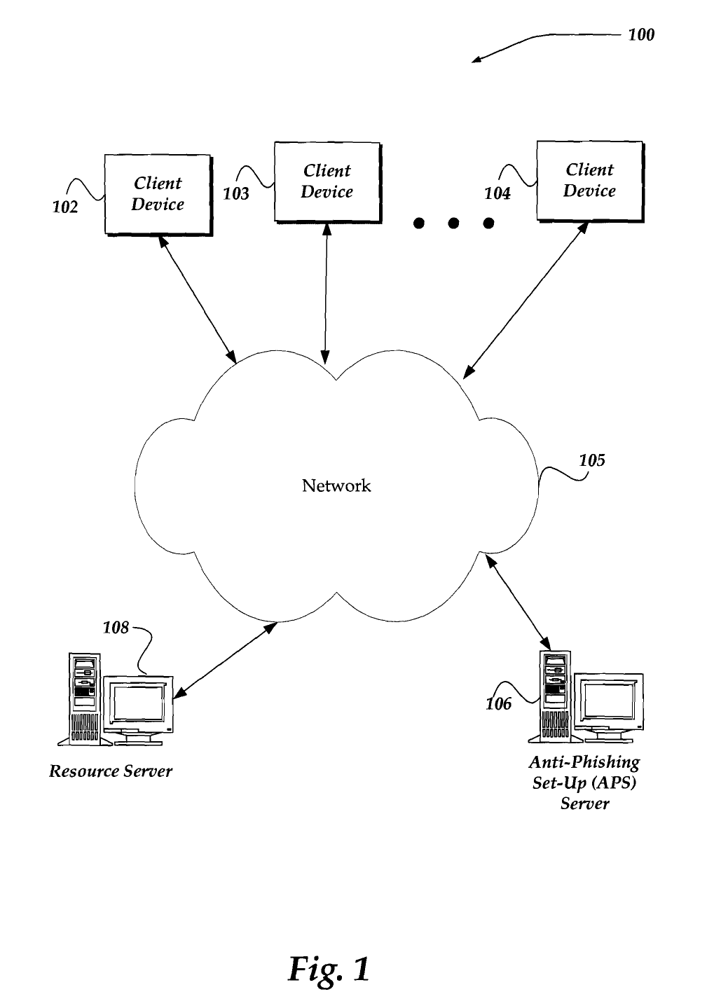

FIG. 1 is a functional block diagram illustrating an exemplary operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes client devices 102-104, network 105, resource server 108, and Anti-Phishing Setup (APS) server 106. Client devices 102-104 are in communication with each other, resource server 108, and APS server 106 through network 105. Resource server 108 and APS server 106 may also be in communication with each other through network 105.

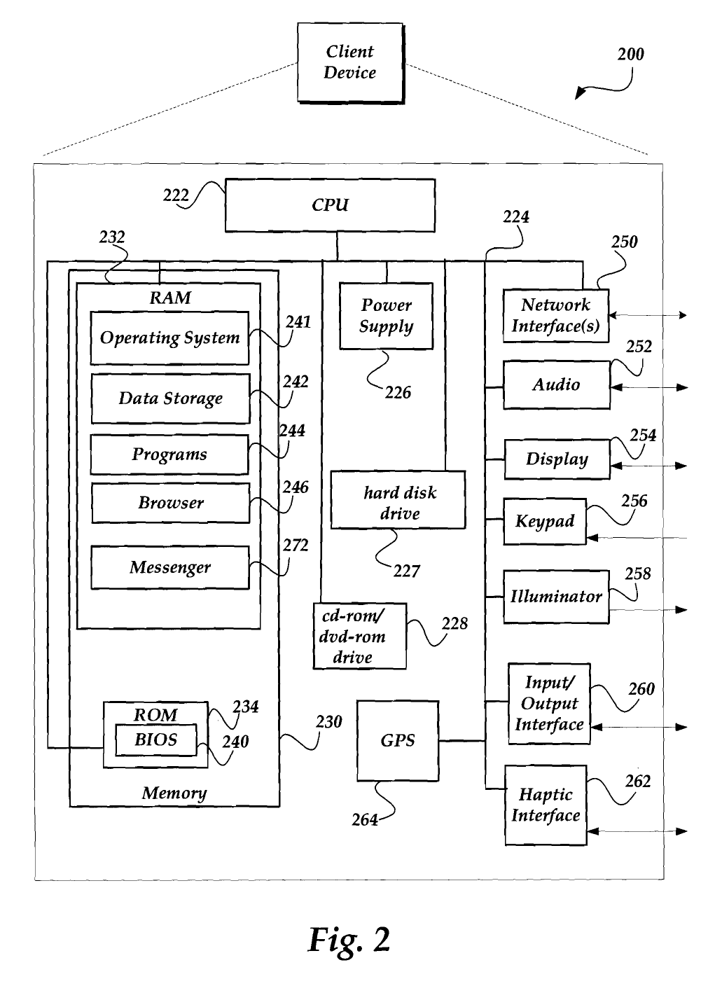

One embodiment of a client device is described in more detail below in conjunction with FIG. 2. Briefly, however, client devices 102-104 may include virtually any computing device capable of receiving and sending a message over a network, such as network 105, to and from another computing device. The set of such devices described in an exemplary embodiment below generally includes mobile devices that are usually considered more specialized devices with limited capabilities and typically connect using a wireless communications medium such as cell phones, smart phones, pagers, radio frequency (RF) devices, infrared (IR) devices, CBs, integrated devices combining one or more of the preceding devices, or virtually any mobile device, and the like. However, the set of such devices may also include devices that are usually considered more general purpose devices and typically connect using a wired communications medium at one or more fixed location such as laptop computers, personal computers, multiprocessor systems, microprocessor-based or programmable consumer electronics, network PCs, and the like. Similarly, client devices 102-104 may be any device that is capable of connecting using a wired or wireless communication medium such as a personal digital assistant (PDA), POCKET PC, wearable computer, and any other device that is equipped to communicate over a wired and/or wireless communication medium.

Each client device within client devices 102-104 may include an application that enables a user to perform various operations. For example, each client device may include one or more messenger applications that enables the client device to send and receive messages to/from another computing device employing various communication mechanisms, including, but not limited to Short Message Service (SMS), Multimedia Messaging Service (MMS), Instant Messaging (IM), internet relay chat (IRC), Mardam-Bey's internet relay chat (mIRC), Jabber, email, and the like. In one embodiment, one or more messenger applications may be configured to setup anti-phishing.

Client devices 102-104 may be further configured with a browser application that is configured to receive and to send content in a variety of forms, including, but not limited to markup pages, web-based messages, audio files, graphical files, file downloads, applets, scripts, text, and the like. The browser application may be configured to receive and display graphics, text, multimedia, and the like, employing virtually any markup based language, including, but not limited to a Handheld Device Markup Language (HDML), such as Wireless Markup Language (WML), WMLScript, JavaScript, and the like, Standard Generalized Markup Language (SGML), HyperText Markup Language (HTML), Extensible Markup Language (XML).

Network 105 is configured to couple client devices 102-104, with other network devices. Network 105 is enabled to employ any form of computer readable media for communicating information from one electronic device to another. In one embodiment, network 105 is the Internet, and may include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 105 may further employ a plurality of wireless access technologies including, but not limited to, 2nd (2G), 3rd (3G) generation radio access for cellular systems, Wireless-LAN, Wireless Router (WR) mesh, and the like. Access technologies such as 2G, 3G, and future access networks may enable wide area coverage for network devices, such as client device 102, and the like, with various degrees of mobility. For example, network 105 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like.

Furthermore, remote computers and other related electronic devices could be remotely connected to either LANs or WANs via a modem and temporary telephone link. In essence, network 105 includes any communication method by which information may travel between client devices 102-104, APS 106, and/or resource server 108.

Additionally, network 105 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

Resource server 108 includes virtually any network computing device that is configured to provide various resources, including content and/or services over network 105. Resource server 108 may provide content and/or services for any of a variety of activities, including, but not limited to merchant businesses, financial businesses, insurance businesses, educational, governmental, medical, communication products, and/or services, or virtually any other site of interest. Many of such activities may communicate over the internet using a variety of mechanisms, including, but not limited to email, webpages, IM, or the like.

Typically, resource server 108 may include an interface that may request sensitive information from a user of client device 102-104. For example, resource server 108 may provide access to an account, which may request user log-in information. Such log-in information may include a user name, password, an entry of a key number, or the like. In another example, resource server 108 may request other sensitive information, such as a credit card number, medical information, or the like. For example, resource server 108 may operate as a merchant site that on at least one webpage of its website, there is a request for entry of sensitive information, including financial information, or the like. In one embodiment, a webpage may include a form or virtually any other data entry mechanism.

Resource server 108 may, in one embodiment, provide a link, or other mechanism to direct a user to APS 106 to enable initial configuration of a client side identification mechanism. In one embodiment, resource server 108 receive the client device data from a client device for use in displaying (or otherwise playing) anti-phishing data that may be used to determine if the user is being phished.

Devices that may operate as resource server 108 include, but are not limited to personal computers, desktop computers, multiprocessor systems, microprocessor-based or programmable consumer electronics, network PCs, servers, network appliances, and the like.

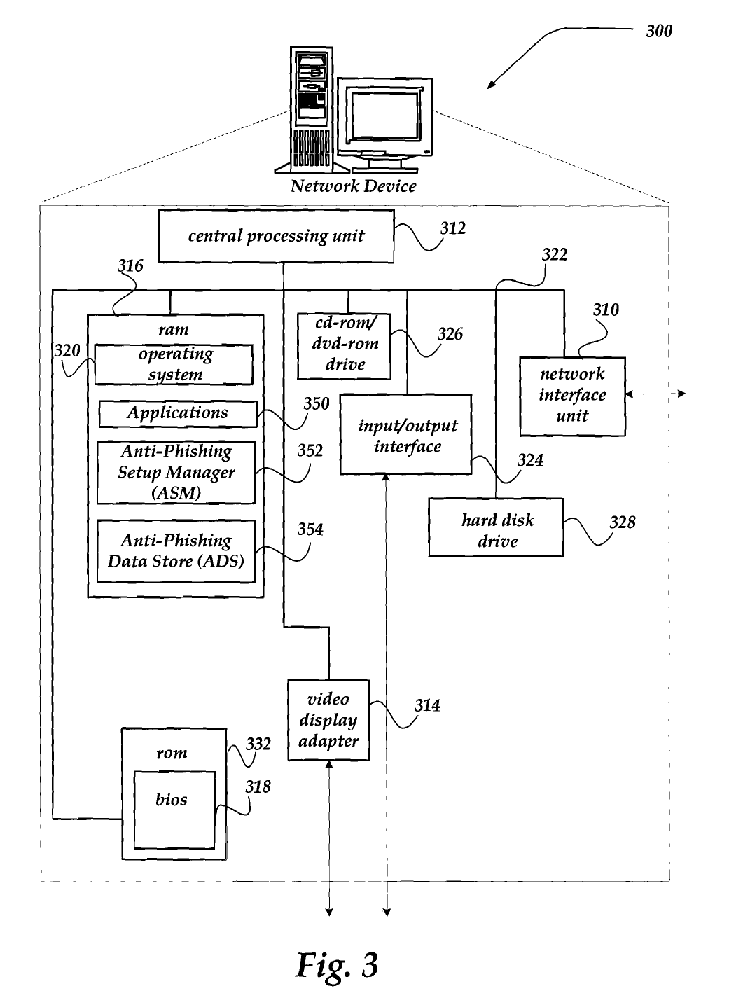

One embodiment of APS server 106 is described in more detail below in conjunction with FIG. 3. Briefly, however, APS server 106 includes virtually any network device that is configured to enable a user to provide and/or configure anti-phishing data for use in authenticating a communication over a network. APS server 106 may be configured to provide an interface that enables the user to provide anti-phishing data. APS server 106 may be further configured to provide client device data to the client device that indicates where the anti-phishing data is to be employed. The client device data may also include information about where the anti-phishing data may be located. In one embodiment, the client device data is structured to be specific to the website, application, or the like. For example, in one embodiment, the client device data is received in the form of a cookie.

APS server 106 may also be configured to interact with resource server 108, an application residing on client devices 102-104, or the like, to enable the application and/or resource server 108 to employ the client device data to display the anti-phishing data.

Although APS server 106 and resource server 108 are illustrated as distinct network devices, the invention is not so limited. For example, a single network device may be configured to perform the operational aspects of APS server 106 and resource server 108, or even a plurality of network devices may be configured such that the operational aspects of APS server 106 and/or resource server 108 are distributed over the plurality of network devices.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. As shown in the figure, client device 200 includes a processing unit 222 in communication with a mass memory 230 via a bus 224.

Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, and the like.

Audio interface 252 is arranged to produce and receive audio signals such as the sound of a human voice, music, or the like. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Client device 200 may further include additional mass storage facilities such as CD-ROM/DVD-ROM drive 228 and hard disk drive 227. Hard disk drive 227 is utilized by client device 200 to store, among other things, application programs, databases, and the like. Additionally, CD-ROM/DVD-ROM drive 228 and hard disk drive 227 may store cookies, data, images, or the like.

Keypad 256 may comprise any input device arranged to receive input from a user (e.g. a sender). For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Haptic interface 262 is arranged to provide tactile feedback to a user (e.g. a sender) of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include an interface with a Java virtual machine module that enables control of hardware components and/or operating system operations via Java application programs.

Client device 200 may also be configured to manage activities and data for one user distinct from activities and data for another user of client device 200. For example, in one embodiment, operating system 241 may be configured to manage multiple user accounts. For example, client device 200 may employ an operating system that is configured to request a user to provide account information, such as a user name/password, smart card, s/key, or the like. When the user logs into the associated account, operating system 241 may then manage data, activities, and the like, for the user separate from at least some of the data, activities, and the like, for another user. Thus, in one embodiment, operating system 241 may be configured to store client device data, cookies, anti-phishing data, or the like, based on a client device account. Moreover, settings, configurations, or the like, of browser 246, messenger 272, or the like, may be based on the user account. Thus, when user A is logged into their client user account, browser 246 may receive, store, and/or retrieve cookies for user A, distinct from cookies associated with another user account on client device 200.

Memory 230 further includes one or more data storage 242, which can be utilized by client device 200 to store, among other things, programs 244 and/or other data. For example, data storage 242 may also be employed to store information that describes various capabilities of client device 200. The information may then be provided to another device based on any of a variety of events, including being sent as part of a header during a communication, sent upon request, and the like. Moreover data storage 242 may be used to store information such as data received over a network from another computing device, data output by a client application on client device 200, data input by a user of client device 200, or the like. For example, data storage 242 may include data, including cookies, and/or other client device data sent by a network device. Data storage 242 may also include image files, anti-phishing data, or the like, for display and/or use through various applications. Moreover, although data storage 242 is illustrated within memory 230, data storage 242 may also reside within other storage mediums, including, but not limited to CD-ROM/DVD-ROM drive 228, hard disk drive 227, or the like.

Programs 244 may also include computer executable instructions which, when executed by client device 200, transmit, receive, and/or otherwise process messages and enable telecommunication with another user of another client device. Other examples of application programs include calendars, contact managers, task managers, transcoders, database programs, word processing programs, spreadsheet programs, games, CODEC programs, and so forth. In addition, mass memory 230 stores browser 246, and messenger 272.

Browser 246 may be configured to receive and to send web pages, forms, web-based messages, and the like. Browser 246 may, for example, receive and display (and/or play) graphics, text, multimedia, audio data, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Similarly, browser 246 may be configured to receive, store, and/or provide data. For example, in one embodiment, browser 246 may receive and store client device data in the form of a cookie, or the like. In one embodiment, browser 246 may also provide the client device data, cookie, or the like over a network when visiting a webpage that matches the cookie rules. In one embodiment, browser 246 is configured to manage data in a persistent manner. For example, when cookies or other data are deleted, using for example, a delete cookie option within browser 246, or the like, a persistent cookies remains, and are not deleted.

Messenger 272 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 272 may be configured as an IM application, such as AOL Instant Messenger, Yahoo! Messenger, .NET Messenger Server, ICQ, or the like. In another embodiment, messenger 272 may be a client application that is configured to integrate and employ a variety of messaging protocols.

Moreover, messenger 272 may be configured to include an interface that may request sensitive user information, such as username/password, credit card information, medical information, or the like. As such, messenger 272 may also enable the user of client device 200 to provide anti-phishing data for use in determining whether messenger 272 is authentic, or whether the user is being phished. In one embodiment, messenger 272 may operate “stand alone,” to configure itself and employ client side identification information for detecting phishing. In another embodiment, messenger 272 may interact with another computing device, such as APS server 106 of FIG. 1, or the like, to identify and employ client side anti-phishing data for use in detecting phishing, or other fraudulent activities.

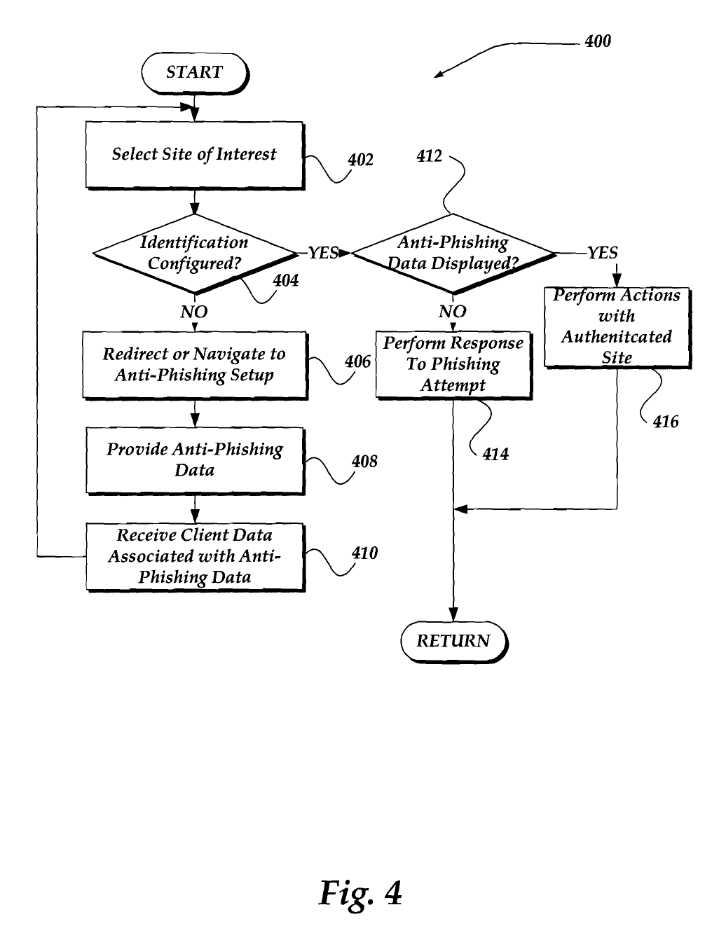

Moreover, client device may employ a process such as described below in conjunction with FIG. 4 to perform at least some of its phishing detection operations.

### Illustrative Server Environment

FIG. 3 shows one embodiment of a network device, according to one embodiment of the invention. Network device 300 may include many more or less components than those shown. For example, network device 300 may operate as a network appliance without a display screen. The components shown, however, are sufficient to disclose an illustrative embodiment for practicing the invention. Network device 300 may, for example, represent distribution server 110 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, network interface card (NIC), or the like.

Network device 300 may also include an SMTP handler application for transmitting and receiving email. Network device 300 may also include an HTTP handler application for receiving and handing HTTP requests, and an HTTPS handler application for handling secure connections. The HTTPS handler application may initiate communication with an external application in a secure fashion.

Network device 300 also may include input/output interface 324 for communicating with external devices, such as a mouse, keyboard, scanner, or other input devices not shown in FIG. 3. Likewise, network device 300 may further include additional mass storage facilities such as CD-ROM/DVD-ROM drive 326 and hard disk drive 328. Hard disk drive 328 is utilized by network device 300 to store, among other things, application programs, databases, or the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs include email programs, schedulers, calendars, transcoders, database programs, word processing programs, spreadsheet programs, security programs, web servers, and so forth. Mass storage may further include applications such Anti-Phishing Setup Manager (ASM) 352, and Anti-Phishing Data Store (ADS) 354.

ADS 354 is configured to store and manage information about associated with anti-phishing data, including, but not limited to cookies, client device data, images, text data, graphical data, audio files, links, and the like. For example ADS 354 may include information that maps a website, application, or the like, to a client device, anti-phishing data, or the like. Thus, ADS 354 may be implemented as a file, a folder, script, a program such as a database, or the like.

ASM 352 is configured to provide an interface to manage setup of a phishing detection mechanism. ASM 352 may enable a user to identify anti-phishing data for use with a website, application, or the like, based on the client device, rather than based on a user's server log-in, remote user account information, user digital certificate, or other non-client device based user authentication mechanisms.

In one embodiment, the user may provide anti-phishing data as an image, text data, audio data, multimedia data, or the like, that may be used to detect phishing. In one embodiment, the user may provide text data, and information about how to display the text data, including a text color, text size, text font type, background color or colors, and the like. In one embodiment, the anti-phishing may be provided over a secure communications channel, using any of a variety of mechanisms, including, for example, HTTPS, SSL/TLS, or the like.

In one embodiment, ASM 352 may convert the provided data to an image. In one embodiment, where an image is provided, ASM 352 may modify the image to accommodate a pre-defined display constraint, such as resolution, size, or the like. ASM 352 may also store the anti-phishing data in ADS 354.

In one embodiment, the anti-phishing data may reside on the client device. As such, in one embodiment, ASM 352 may receive a location identifier that indicates where on the client device the anti-phishing data may be located. In one embodiment, ASM 352 may also receive the anti-phishing data, modify it, and provide it back to the client device. In yet another embodiment, ASM 352, may enable the user to select pre-defined images, text, audio data, multimedia data, or other anti-phishing data rather than providing their ‘own’ anti-phishing data.

ASM 352 may employ various mechanisms to associate the anti-phishing data to a client device, and to an application, website, or the like. For example, in one embodiment, ASM 352 may employ a cookie to manage client device data that link the anti-phishing data with the client device, application, and/or website. The client device data may, in one embodiment, be encrypted using any of a variety of encryption mechanisms. In one embodiment, the client device data may also be digitally signed to identify the website, application, or the like, for which the client device data is associated. ASM 352 may then provide the client device data in the form of a cookie to the client device, in one embodiment. In one embodiment, ASM 352 may further interact with the website, application, or the like, to enable it to request and display the anti-phishing data at an appropriate operation, including, for example, before or when sensitive information may be requested. ASM 352 may also be configured to modify an application, such as a messenger client application, or the like, based on the anti-phishing data, and to provide the modified application to the client device. In one embodiment, ASM 352 may employ at least a portion of process 500 to perform some of its actions.

### Generalized Operation

FIG. 4 illustrates a flow diagram generally showing one embodiment for a client process of managing a client side authenticating a communication over a network. Process 400 of FIG. 1 may, for example, be implemented within at least one of client devices 102-104 of FIG. 1.

Process 400 begins, after a start block, at block 402 where a user of a client device selects a site of interest. The site of interest may include a log-in webpage at a website, a webpage that for entry of financial information or a webpage at a network site that may request virtually any sensitive information from a user. Moreover, although the process describes a networked website as the site of interest, the invention also encompasses applications, such as messenger applications, financial applications, or the like, that may also request sensitive information. In one embodiment, as the user selects the site of interest, if the client device is already so configured, the client device may provide client device data to the server device hosting the site of interest. In one embodiment, the client device data may be provided through an HTTP request within an encrypted cookie.

Process 400 then flows to decision block 404 where a determination is made whether the site of interest is configured with client device side phishing detection. In one embodiment, if the client device has not provided anti-phishing data for this site, then an icon, link, or other indicator is displayed to the user. The user of the client device may then select the indicator to identify that the anti-phishing data is not provided, but intends to provide it. Processing flows to block 406. If however, the user does not see the indicator, the user has already provided anti-phishing data for the client device, the indicator appears to be suspect or the like, processing flows to decision block 412.

At block 406, selection of the indicator redirects or otherwise navigates the user to a setup interface that is configured to enable the user to provide and/or configure anti-phishing data for the present client device. In one embodiment, the redirection may include establishing a secure communications channel with the client device. In one embodiment, a SSL/TLS communications session may be established, in part, using a server-side digital certificate for authentication.

Processing continues to block 408, where the user may provide and/or configure anti-phishing data for the client device independent of being user authenticated through the setup interface or server device, or otherwise providing user authentication data. Thus, in one embodiment, the anti-phishing data may be user independent. In another embodiment, the anti-phishing data is based merely on any user authentication that may be performed for the client device. In one embodiment, the user may provide an image file. In another embodiment, the user may provide text and/or characteristics for the display of the text. In another embodiment, the user may provide a combination of text, graphical data, audio data, or the like. In one embodiment, the user may also record voice data, and/or other audio data as the anti-phishing data. In still another embodiment, the user may provide a combination of an image and/or voice data. Thus, the invention is not constrained the type or combination of anti-phishing data that may be provided. In one embodiment, the anti-phishing data may be provided to the setup interface. In another embodiment, the user may provide to the setup interface information indicating a location of the anti-phishing data. For example, in one embodiment, the user may elect to retain the anti-phishing data on the client device. Therefore, the user may elect to provide a file name or names, and location(s) for the anti-phishing data. In one embodiment, the anti-phishing data may be modified to accommodate pre-defined display constraints. For example, in one embodiment, the graphical data might be modified based on its size, resolution, or the like. In one embodiment, the text data may be converted to an image.

Processing may then flow to block 410, where client device data associated with the client device and anti-phishing data is provided. In one embodiment, the client device data is specific to the client device. For example, the client device data may include information that is intended to uniquely identify the client device, including a network address, a MAC address, an operating system characteristic of the client device, a hardware characteristic of the client device, and/or any combination of hardware, network, and/or software characteristics. In one embodiment, the client device data includes an identifier associated with the site of interest. In another embodiment, the client device data includes an identifier that enables locating the anti-phishing data. In one embodiment, the client device data is encrypted. In another embodiment, the client device data is provided to the client device in a cookie.

Although not shown, the user of the client device may modify the anti-phishing data provided during an earlier setup activity. In addition, during block 408 (or even at block 410), the user may request a preview of how the anti-phishing might appear at the site of interest. In any event, the user may, at some point in the process, select to return to the site of interest, in which case, processing loops back to block 402.

Continuing from decision block 412, a determination is made whether the anti-phishing data is displayed at the site of interest. In one embodiment, it is expected that a communication between the site of interest and the client device includes sending of the client device data. The client device data is sent to the servers based on a rule that may be defined with the client data. For example, one rule might be implemented that states that a browser may send the cookie only to a server that matches the criterion defined when the cookie was issued. This criterion may include, but are not limited to using existing technologies, such as DNS, SSL/TLS, or the like. In one embodiment, the anti-phishing data, if provided, might be provided using a transient form, such as through a temporary URL, or the like. Thus, at decision block 412, if the anti-phishing data is not displayed processing flows to block 414; otherwise, processing flows to block 416.

At block 414, the user may then perform actions in response to the detected phishing attempt. For example, the user may elect to terminate a communication with the site, provide a communication message to a known authority, or the like. In any event, process 400 may then return to a calling process to perform other actions.

At block 416, the anti-phishing data is displayed/played to the user of the client device. In one embodiment, the anti-phishing data is displayed/played within a webpage through a link to the anti-phishing data. In this manner, the anti-phishing data is not provided directly to the site of interest. In one embodiment, the link may be implemented to be valid for a pre-defined period of time. Thus, in one embodiment, the link may expire after the pre-defined period of time, thereby restricting access to the anti-phishing data. At block 416, the user may then perform actions based on a determination that the site is authentic because, at least in part, it displays the client device's anti-phishing data. Process 400 may then return to the calling process to perform other actions.

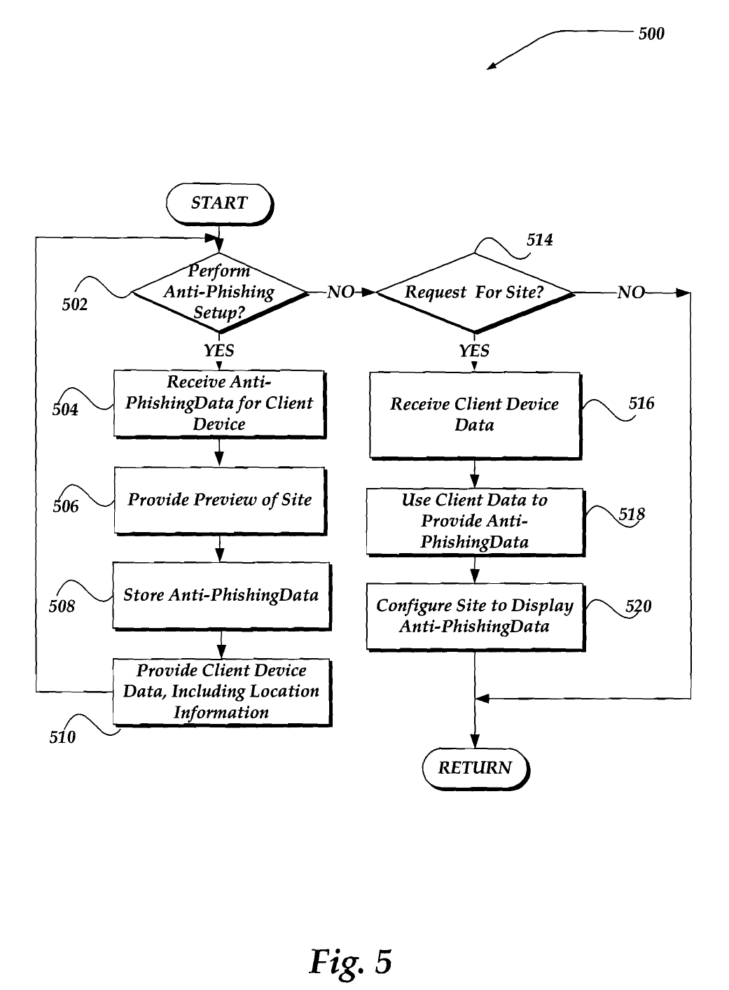

FIG. 5 illustrates a flow diagram generally showing one embodiment for a server or service oriented process of managing a client side authenticating a communication over a network in accordance with the invention. Process 500 of FIG. 5 may be implemented, in part, in APS server 106 and/or resource server 108 of FIG. 1. Moreover, it should be recognized that process 500 may also be implemented with an application, such as a messenger application, or the like.

Process 500 begins, after a start block, at decision block 502. At decision block 502, a determination is made whether a request to perform setup for phishing detection is received. For example, in one embodiment, a client device may provide an indication, such as selection of a link, icon, or the like, that directs the client device to an anti-phishing setup interface. If such indication is received, processing proceeds to block 504; otherwise, processing flows to decision block 514.

At block 504, anti-phishing data is received for the client device. As described above, the anti-phishing data may be received over a secure communications channel. Moreover, in one embodiment, the anti-phishing data may include an image, text, characteristics associated with the text, image, or the like, an audio file, or the like. In one embodiment, the anti-phishing data may include a location identifier that indicates where the anti-phishing data may be located on the client device. Processing then continues to block 506, where the anti-phishing data may be modified. Then a preview of the proposed display including the anti-phishing data is provided to the client device for review. If the user of the client device decides, the user may return to block 504 to provide different anti-phishing data, modified anti-phishing data, or the like. Processing then flows to block 508, where the user may indicate that the provided anti-phishing data is to be employed. Thus, at block 508, in one embodiment, the anti-phishing data may be stored. In one embodiment, the anti-phishing data is stored on a remote network device. In another embodiment, the anti-phishing data may be stored on the client device. In any event, client device data is then prepared that includes information indicating where the anti-phishing data is located.

In addition, the client device data is further prepared to indicate with which site the client device data is associated. In one embodiment, the client device data may include a numeric value, a network address, or the like, indicating the site (or application). The client device data may also include information that is intended to uniquely identifier the client device, as described above. In one embodiment, the client device data is encrypted. In another embodiment, the client device data is included within a cookie. Processing then flows to block 510, where the client device data is provided to the client device. Process 500 then loops back to decision block 502.

Continuing from decision block 514, a determination is made whether a request for a site of interest is received. In one embodiment, blocks 514, 516, 518, and 520 are performed by a different network device, such as resource server 108 of FIG. 1. If, at decision block 514, a request for a site of interest is received, processing flows to block 516, where the network device (or application) may request the client device to provide the client device data; otherwise, process 500 returns to a calling process. In one embodiment, the client device data is received within cookie. Processing then flows to block 518, where the client device data is employed to locate the anti-phishing data.

Processing continues next to block 510, where the client device data is used to configure the site with the anti-phishing data. In one embodiment, the anti-phishing data is inserted into a webpage, or the like, for display. In one embodiment, a link to the anti-phishing data is inserted into the webpage, rather than the anti-phishing data itself. In one embodiment, the link is configured to expire after a pre-defined period of time. For example, in one embodiment, the link may be configured to expire after about 10-60 seconds. However, the invention is not limited to these values, and others may also be used. The modified webpage, screen display or the like is then provided to the client device. Processing then returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause operational steps to be performed by the processor to produce a computer implemented process such that the instructions, which execute on the processor to provide steps for implementing the actions specified in the flowchart block or blocks. In one embodiment, at least some of the operational steps may be performed serially; however, the invention is not so limited, and at least some steps may be performed concurrently.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A client device for detecting phishing over a network, comprising:
a transceiver for receiving and sending information over the network;
a processor in communication with the display and the transceiver; and
a memory in communication with the processor and for use in storing data and machine instructions that causes the processor to perform a plurality of actions, including:
providing anti-phishing data over the network;
in response to providing the anti-phishing data, receiving client device data associated with the anti-phishing data and a webpage;
requesting the webpage;
providing the client device data to a network device associated with the webpage; and
displaying the anti-phishing data with the requested webpage if the webpage is authentic.

2. The client device of claim 1, wherein providing and displaying the anti-phishing data is independent of a user authentication by the webpage.

3. The client device of claim 1, wherein the actions further comprises:
accessing the webpage, wherein the webpage is configured to receive sensitive information; and
selecting a link to an anti-phishing setup interface.

4. The client device of claim 1, wherein providing the anti-phishing data further comprises providing a rule, and wherein providing the client device data to a network device further comprises employing the rule to determine whether to provide the client device data to the network device.

5. The client device of claim 4, wherein the rule comprises criterion indicating that the client device data should be provided only to a defined network device.

6. The client device of claim 1, wherein the anti-phishing data comprises an image.

7. The client device of claim 1, wherein the client device data is provided in a cookie.

8. The client device of claim 1, wherein the client device data further comprises information that is based in part on a characteristic of the client device.

9. The client device of claim 1, wherein the actions further comprise:
if the requested webpage displays the anti-phishing data, providing sensitive information over the network.

10. A processor readable storage medium having computer-executable 3 instructions, wherein the execution of the computer-executable instructions provides for detecting a phishing attack by enabling actions, including:
associating anti-phishing data to a website independent of user authentication with the website, wherein the anti-phishing data is associated with a client device;
receiving a cookie that includes data about the anti-phishing data and the website;
requesting a webpage associated with the website, wherein the webpage is configured to receive sensitive information;
providing the cookie to the website; and
detecting a phishing attempt based on whether the anti-phishing data is displayed by the website.

11. The processor readable storage medium of claim 10, wherein associating anti-phishing data to the website further comprises: identifying an image file and a location of the image file.

12. The processor readable storage medium of claim 10, wherein associating anti-phishing data to the website further comprises: identifying text and a characteristic of the text.

13. The processor readable storage medium of claim 10, wherein the cookie contents are encrypted.

14. The processor readable storage medium of claim 10, wherein the webpage is configured to receive sensitive information further comprises the webpage is configured to receive log-in information.

15. The processor readable storage medium of claim 10, wherein the anti-phishing data is user independent.

16. The processor readable storage medium of claim 10, wherein detecting whether the requested webpage is phished further comprises:
if the requested webpage is displayed absent the anti-phishing data, indicating a phishing attempt; and
if the requested webpage is displayed with the anti-phishing data, indicating that a phishing attempt is undetected.

17. A network device for detecting a phishing attack, comprising:
a transceiver to send and receive data over a network; and
a processor that is operative to perform actions, including:
receiving from a client device, information for anti-phishing data for a website, independent of user authentication at the network device;
associating the client device with the anti-phishing data through client device data;
providing the client device data to the client device; and
if a webpage associated with the website is requested by the client device, employing the client device data to locate and display the anti-phishing data with the webpage to indicate a non-presence of a phishing attempt.

18. The network device of claim 17, wherein the information for the anti-phishing data further comprises, receiving location information indicating where on the client device the anti-phishing data is stored.

19. The network device of claim 17, wherein the anti-phishing data comprises voice data.

20. The network device of claim 17, wherein associating the client device with the anti-phishing data further comprises incorporating into a cookie, a location of the anti-phishing data.

21. The network device of claim 17, wherein the client device data further comprises at least one characteristic of the client device.

22. A method of detecting a phishing attack over a network, comprising:
receiving from a first device, information for anti-phishing data for a second device;
associating the first device with the anti-phishing data through first device data;
providing the first device data to the first device; and
if an application associated with the second device is requested by the first device and the second device is authentic, receiving from the first device the first device data, and employing the first device data, in part, to display the anti-phishing data.

23. The method of claim 22, wherein the first device data is provided through an encrypted cookie.

24. The method of claim 22, wherein information for anti-phishing data includes information identifying a location of the anti-phishing data, including at least one of a location on the first device, or a location on a network device.

25. (canceled)

26. A network device for use in detecting a phishing attack over a network, comprising:
a transceiver that send and receive data over a network;
means for identifying anti-phishing data to another network device for the network device independent of user authentication to the other network device; and means for indicating whether the network device is being phished based, in part, on the anti-phishing data.
